(19) United States
(12) Patent Application Publication
(10) Pub. No.: US 2010/0161507 A1
(43) Pub. Date: Jun. 24, 2010

(54) GPS RATING SYSTEM

(76) Inventor: James O. McKenzie, III, Birmingham, AL (US)

Correspondence Address: W. EDWARD RAMAGE, COMMERCE CENTER SUITE 1000, 211 COMMERCE ST, NASHVILLE, TN, 37201, US

(21) Appl. No.: 12/642,798

(22) Filed: Dec. 19, 2009

Related U.S. Application Data
(60) Provisional application No. 61/139,271, filed on Dec. 19, 2008.

(51) Int. Cl. G06Q 99/00; H04W 64/00; G01S 19/13; G06F 17/30

(52) U.S. Cl. 705/347; 455/456.3; 342/357.08; 707/758; 707/E17.014; 707/802; 707/E17.044

(57) ABSTRACT

A system for using GPS or location-aware devices to solicit and collect rating information of businesses of interest. Businesses of interest include, but are not limited to, restaurants, gas station, bars, hotels, and motels. The user or consumer uses the GPS or location-aware device to rate the business, or its components, after having visited the business. The rating is a discrete number or letter grade. Alternatively, the user could provide open-ended feedback, which could be at the user's discretion. The device may be a handheld device with GPS capabilities, such as a personal digital assistant (PDA), cell phone, Smart phone, or the like. The device also may be a device used in a motor vehicle.

This application claims benefit of and priority to U.S. Provisional Application No. 61/139,271, filed Dec. 19, 2009, by James 0. McKenzie III, and is entitled to that filing date for priority. The specification, figures and complete disclosure of U.S. Provisional Application No. 61/139,271 are incorporated herein by specific reference for all purposes.

### FIELD OF INVENTION

This invention relates to a method and system for using a Global Positioning System (GPS) or similar triangulation system to generate and collect user or consumer ratings for selected businesses.

### SUMMARY OF INVENTION

In various embodiments, the present invention comprises a system for using GPS or location-aware devices to solicit and collect rating information of businesses of interest. Businesses of interest include, but are not limited to, restaurants, gas station, bars, hotels, and motels. The user or consumer uses the GPS or location-aware device, which comprises a microprocessor, to rate the business, or its components, after having visited the business. The rating may be verified by location.

In one embodiment, the rating is a discrete number or letter grade (e.g., a number on a 1 to 5 scale). Alternatively, the user could provide open-ended feedback, which could be at the user's discretion. In yet another embodiment, the user could provide both a discrete rating and open-ended feedback.

The device may be a handheld device with GPS capabilities, such as a personal digital assistant (PDA), cell phone, Smart phone, or the like. The device also may be a device used in a motor vehicle.

### DESCRIPTION OF THE DRAWINGS

FIG. 1 shows a diagram of a system in accordance with an embodiment of the present invention.

### DETAILED DESCRIPTION OF EXEMPLARY EMBODIMENTS

In one exemplary embodiment, the system uses location-aware technology, such as GPS or triangulation systems, which identify businesses of interest to users in particular locations (such as a section of a city, exit on a highway, or the like). Businesses of interest include, but are not limited to, restaurants, gas station, bars, hotels, and motels. The user or consumer uses the GPS or location-aware device, which comprises a microprocessor, to rate the business, or its components, after having visited the business. The rating may be verified by location.

In one embodiment, the rating is a discrete number or letter grade (e.g., a number on a 1 to 5 scale). Alternatively, the user could provide open-ended feedback, which could be at the user's discretion. In yet another embodiment, the user could provide both a discrete rating and open-ended feedback.

The device may be a handheld device with GPS capabilities, such as a personal digital assistant (PDA), cell phone, Smart phone, or the like. The device also may be a device used in a motor vehicle. In general, these devices have a video screen or other display means, and a keyboard, touchscreen, or other form of user interface for receiving user input.

The system may prompt the user or consumer for input. In one embodiment, the system uses the amount of time spent at a location as a primary determination for when to ask for a user rating. After a set amount of time spent at an appropriate location, such as 5 minutes, the system would prompt the user for feedback. At that time, the user would be able to input his rating, via the location-aware device, or to decline to rate the business.

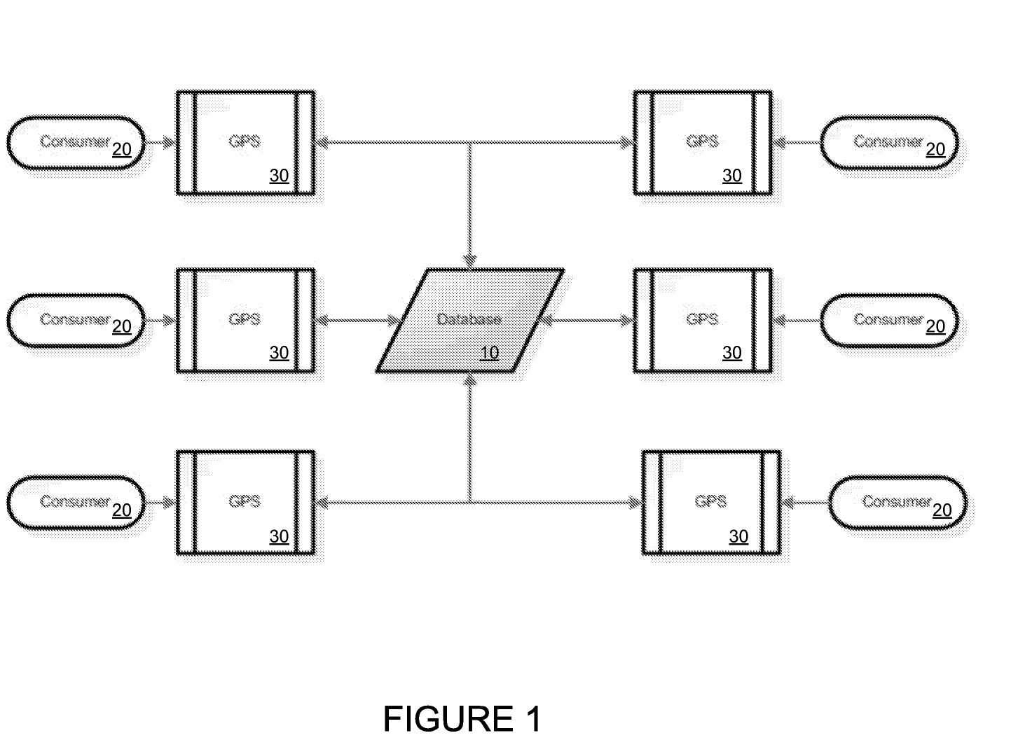

The consumer ratings may be uploaded and aggregated, along with other consumer ratings and reviews from other sources, into one or more computer databases 10, as seen in FIG. 1. The databases may be centralized or decentralized. This database (or databases) would be used to provide ratings back to consumers and users 20 when they were searching for businesses via their location-aware devices 30. Similarly, businesses could access the databases to review ratings. The users and/or businesses would be able to see both discrete ratings, and well as open-ended user feedback via their location-aware device, in addition to being able to submit ratings and reviews via that device's input system.

In another exemplary embodiment, the system comprises one or more databases 10 in electronic communication with one or more physical or virtual application servers connected to the Internet, or similar network. The database comprises data about one or more businesses, including but not limited to the business name, address, city, state, zip code, and location. Business location may be described by a single latitude and longitude marking the center of the physical location or the business, or it may be a set of latitude and longitude points describing the boundaries of the physical location of the business. Business location may also include elevation data (i.e., height above sea level). The application servers can, among other things, query the database(s) to retrieve data for use in locating businesses in the proximity of, or encompassing, a particular locations, save user feedback or ratings on a business, retrieve feedback or rating data for business intelligence reporting, and perform other similar functions.

In one embodiment, the system further comprises a set of software services, which allow applications with access to the Internet (or network) to access the above functions provided by the application servers without having direct physical access to those services. The user GPS or mobile devices 30 also may have an application residing on the device to interact with the software services or the application servers. The device provides the most precise global positioning (including elevation, if available) to the system as possible, and serves as the user's primary interface to the system.

In this embodiment, the device application utilizes the device's GPS to determine the user's current location. This process is described as location polling. Location polling may be continuous, or may be done at regular time intervals, so that the device application can determine when the user's location is static or unchanged (or nearly so). Once this condition has been detected, the device application calls the service to retrieve the closest business as determined by either a straight distance calculation (if the system only has a single latitude/longitude point for the business) or by determining if the user's 20 current location is within or bound by a business perimeter as defined in the database. The servers make the determination, using a computer processor or microprocessor, of whether or not the user is proximate enough to a business to be within a certain distance or “zone of control” of the business. If so, the server returns the business data to the device. The device stores this data in its local memory store, and continues location polling. If the user is still in the same business zone after a set period of time, the user is determined by a processor or microprocessor to have visited that business. After the user has been determined to have visited a business, the device prompts the user to rate his or her experience at the business. Once the user inputs their rating value the device sends that data to the software services, which in turn pass the data to the servers which stores the data in the database(s).

In another exemplary embodiment, users would be able to search for businesses by variables such as, but not limited to, location, type, and rating, or some combination thereof (e.g., find all Sushi restaurants with a rating of 4 or above).

The system may be independent of any particular location-aware device or technology, allowing the gathering and aggregation of feedback from many different systems. Customized applications may also be provided for certain devices and platforms.

In yet another embodiment, ratings and feedback information may also be available for review via the Internet (such as through a personal computer with browser software), and may be modified through that means as well.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, routines, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media and may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A rating device, comprising:
a device with global positioning capability, wherein a user is prompted to provide a rating for a business within a certain distance of the device when the device has remained within that distance for a period of time.

2. The rating device of claim 1, wherein the device is a hand-held device.

3. The rating device of claim 2, wherein the device is a cell phone or personal digital assistant.

4. The rating device of claim 1, wherein the device is in a motor vehicle.

5. The rating device of claim 1, wherein the location of the rating device is continuously or periodically polled, and compared to the location of businesses in a computer database.

6. A method of collecting ratings, comprising the steps of:
polling the location of a device with global positioning capability;
comparing using a processor or microprocessor the location of the device to the location of businesses in the proximity of the device; and
determining the length of time the device is within an established distance of one or more businesses.

7. The method of claim 6, further comprising the step of sending a request for rating input on the one or more businesses.

8. The method of claim 7, further comprising the step of receiving rating data on the one or more businesses.

9. The method of claim 8, further comprising the step of storing rating data in one or more databases.

10. The method of claim 8, wherein the rating data comprises a discrete number or letter, or combination thereof.

11. The method of claim 8, wherein the rating data comprises open-ended data.

12. A system for obtaining and reviewing ratings on businesses, comprising:
one or more computer databases in electronic communication with one or more computer servers, wherein said database comprise data about one or more businesses;
one or more devices with global positioning capability, said devices at least in periodic communication with one or more of the computer servers; and
an executable computer program stored on non-transitory, computer-readable storage medium in a device or computer server, wherein the program instructs a processor or microprocessor to perform the following steps:
polling the location of a device with global positioning capability;
comparing using a processor or microprocessor the location of the device to the location of businesses in the proximity of the device; and
determining the length of time the device is within an established distance of one or more businesses.

13. The system of claim 12, further wherein the program solicits rating input for the one or more businesses from the user of the device if the length of time the device is within an established distance of the one or businesses exceeds a threshold.

14. The system of claim 13, wherein the rating input data is stored in the one or more databases.

15. The system of claim 14, wherein the rating input data may be used as a search parameter.
